(19) United States
(12) Patent Application Publication
(10) Pub. No.: US 2013/0305864 A1
(43) Pub. Date: Nov. 21, 2013

(54) HARMONIC DRIVE WITH STIFFNESS-OPTIMIZED WAVE GENERATOR

(71) Applicants: Jens Schaefer, Herzogenaurach (DE); Mike Kohrs, Oberreichenbach (DE); Jeffrey S. Balko, Herzogenaurach (DE)

(72) Inventors: Jens Schaefer, Herzogenaurach (DE); Mike Kohrs, Oberreichenbach (DE); Jeffrey S. Balko, Herzogenaurach (DE)

(21) Appl. No.: 13/981,340

(22) PCT Filed: Dec. 7, 2011
(86) PCT No.: PCT/EP2011/072078

§ 371 Date: Jul. 24, 2013

(30) Foreign Application Priority Data
Feb. 14, 2011 (DE) 10 2011 004 074.9

(51) Int. Cl. F16H 49/00

(52) U.S. Cl. CPC F16H 49/001
USPC 74/412 R

(57) ABSTRACT

A shaft transmission including at least one annulus having an inner gearing, a flexible spur gear arranged within the annulus and having an outer gearing, and a shaft generator for deflecting the spur gear in radial direction arranged within the spur gear, a torque-transmitting connection being created between the annulus and the spur gear at two opposing points of the spur gear, the shaft generator having a ring with an elliptical outer periphery and an elliptically shaped rolling bearing applied to the outer periphery, the rolling bearing having an outer ring (01), an inner ring (02) and two rows of rolling elements (03) arranged between the outer ring (01) and the inner ring (02).

### BACKGROUND

The invention concerns a shaft transmission. The invention further concerns a shaft generator that is suitable for use in a shaft transmission of the precited type.

Shaft transmissions are known from the prior art. By way of example, reference may be made here to DE 102 22 695 A1. Shaft transmissions normally comprise a cylindrical rigid ring comprising an inner gearing or, alternatively, also two cylindrical rigid rings comprising an inner gearing, a flexible gearwheel comprising an outer gearing, which gearwheel is arranged in the interior of the rigid annulus, and further comprising a shaft generator that is fitted into the interior of the flexible gearwheel. The shaft generator is made up of a rigid shaft transmission insert with an elliptical outline and a shaft transmission bearing that is fitted onto an outer peripheral surface of the shaft transmission insert so that the flexible gearwheel is bent into an elliptical shape and the outer gearing of the gearwheel, which is arranged on each of the two ends of the main axis of the elliptical shape, meshes with the inner gearing of the rigid gearwheel. When the shaft generator is rotated through a motor or the like, the parts of the two gearwheels in mesh with each other, move in peripheral direction. Because there is a difference in the number of teeth between the outer gearwheel and the inner gearwheel, a relative rotation is created between these gearwheels in accordance with the difference in the number of teeth. Typically, the difference in the number of teeth is two.

Depending on their structure, shaft transmissions are sub-divided into pot-type transmissions, bushing-type transmissions and flat transmissions. In the case of pot-type transmissions, the flexible gearwheel is configured with a pot shape comprising a bottom that is flange-mounted on the driven shaft. The multiplication annulus is used as a flange for connection to the periphery. In the case of bushing-type transmissions, the flexible gearwheel is configured with a ring shape. For this purpose, two annuli are used, a multiplication gearwheel and a clutch gearwheel, the clutch gearwheel having the same number of teeth as the flexible gearwheel, and the multiplication gearwheel having a larger number of teeth than the flexible gearwheel. During a fast rotation of the shaft generator at a low torque, a relative rotation between the two annuli takes place. The reduced rotational speed and the high torque can be taken up between the annuli. The flat transmission is frequently used in camshaft drives.

Shaft transmissions can be used as electromechanical phase adjusters or camshaft adjusters in triple shaft systems. The shaft system receives its driving power through the drive shaft, e.g. a camshaft chain pulley, which power is then released again through the driven shaft, e.g. camshaft. The phase adjuster serving as an adjusting member is arranged within the power flow as a connecting member between the drive shaft and the shaft to be adjusted. This enables, through a third shaft, the adjusting shaft, to also transfer, overlying the driving power, mechanical power into the shaft system, or a withdrawal of this power out of the system. In this way, it is possible to vary the moving function defined by the drive shaft relative to the driven shaft, e.g. a phase offset can be realized. Often used actuators for displacing the adjusting shafts in such triple shaft systems are electro motors. However, it is likewise possible to enable phase adjustment through electric, mechanical or hydraulic brakes, electro magnets with a rotary or linear action, magnetic valves or linear motors or linear actuators.

In order to protect the periphery from undesired collisions of components in case of control errors in the actuating system, the adjusting range or drive range, as the case may be, is limited as a rule through the limitation of the angle of rotation of one of the three shafts relative to a second shaft, or relative to the housing. For this purpose, a mechanical stop made as an integral part of the device is used. This stop can be arranged between driving and driven shaft, between driving shaft and adjusting shaft or between driven shaft and adjusting shaft. In the prior art, the stop is realized as a rule between the driven shaft and the driving unit. The limitation of the driven angle in the prior art is effected always only uniquely between two transmission shafts, and never doubly, i.e. between power-take-off and drive as also between adjusting shaft and drive or between adjusting shaft and power-take-off.

Moreover, shaft transmissions can also be used in double shaft arrangements of a triple shaft transmission an adjusting drives. In this case, the shaft transmissions are mostly used as reduction devices for adjusting drives in the automatic field as also in industrial applications. Reduction devices serve to convert a driving power of an adjusting element delivered at a high speed and low load into an output power at a low speed and high load. Power is transmitted only between adjusting shaft and driven shaft. The third shaft of the transmission is fixed to the housing. The angle of the driven shaft can be more than 360°.

In order to protect the periphery from collisions of components in case of control errors in the actuating system, it is also possible to limit the angle of rotation of the power take-off through a mechanical limitation. The stop can be arranged between adjusting shaft and driven shaft, between driven shaft and housing or between adjusting shaft or drive shaft and housing. The stop is usually realized between the driven shaft and the housing. It is also possible to provide, exclusively or additionally, limitations of the adjusting path through the controlling device. In this case, the path of the driven shaft is primarily pre-defined by the adjusting path of drive shaft or the adjusting shaft defined by the controlling device. The stop then serves only for guaranteeing fail-safe states.

As just described above, the limitation of the adjusting range is effected in most cases between drive shaft and driven shaft, or between driven shaft and the housing of the device. The adjusting shaft, not limited directly in the adjusting angle or drive angle, is decelerated through the transmission kinematics and the rigidity of the transmission members as soon as the power take-off reaches the limit of the angle of rotation. The prior art does not define any measures for damping the action of pulse loads occurring in the adjusting member upon reaching the stop. As a consequence of high loads, the transmission members can get deformed so strongly that they collide with one another and cause the adjusting member to get jammed. Further, transmission members can get prematurely fatigued or must be configured with an oversize for normal operation in order to support even the high loads in the unbraked stop. This state can also occur if the adjusting member is abruptly decelerated outside of a possibly existing stop through the controls or due to a collision (stop outside of the system).

As already described above, the principle of the shaft transmission is based on a thin-walled flexible spur gear that can be ovalized all around through the shaft generator. Due to this flexibility of the spur gear, however, the spur gear can also deflect in the tooth contact both in radial and axial direction as also in tangential direction. As soon as the deformation or displacement of the spur gear deviates from the transmission kinematics, meshing irregularities and collisions between the transmission components and the gearings can occur. With the single row bearings hitherto normally used in the shaft generator, it is not possible to prevent a radial deviation under load because the outer ring yields when a rolling element gap runs into the load zone. Analogously to the outer ring, the flexible spur gear also gets deformed. This results in an unfavorable contact pressure distribution in the tooth contact. Under axially unsymmetrical load application, this can lead to a stronger twisting of the periphery of spur gear between the loaded and non-loaded sectors. Moreover, due to the inadequate support in the gearing, it is more probable for the shaft transmission to get overloaded, and this can result in clamping or tripping.

### SUMMARY

The object of the present invention is therefore to provide an improved shaft transmission in which the radial deviations occurring in the tooth contact under load are prevented or minimized, so that the transmission components are better protected from overloads, and a clamping or a damage of the transmission components is substantially prevented. Through this feature, it is also intended to achieve an improved bearing capacity for pulse loads upon abutment in the end stop.

To achieve the above object, the invention provides a shaft transmission in which two rows of rolling elements are arranged between the outer ring and the inner ring of the shaft generator.

An important advantage of the shaft transmission according to the invention is that the rigidity is enhanced by the use of a double row bearing. In double row bearings, the flexible spur gear has an improved protection compared to hitherto used single row bearings. In a double row bearing, the deformation when a rolling element gap runs into a load zone is smaller, so that the protection of the gearing is improved and the transmission is subjected to a lower load. In this way, a clamping and a resulting damage of transmission components are substantially prevented.

According to an advantageous form of embodiment, the rolling elements are needle rollers or cylindrical rollers. Needle rollers or cylindrical rollers provide a particularly good support of the gearing so that a further improvement in the sense of an overload protection of the shaft transmission is achieved. It is naturally also possible to use balls as rolling elements.

It has proved to be advantageous to arrange the rolling elements offset to one another. Due to this offset arrangement of the rolling elements, the tooth mesh is almost always supported directly through rolling elements in radial direction. This results in the formation of a short, rigid bending beam.

According to an advantageous form of embodiment, the rolling elements are arranged in a rolling element cage. A contact of the rolling elements with one another is intended to be avoided through an appropriate configuration of the rolling element cage, for example, in the form of a snap cage. In this way, among other things, friction losses are avoided.

It has proved to be further advantageous to let the rolling elements overlap one another in axial direction. In this case, two rolling element rows are arranged with an axial overlap of 1% to 99% of their ball diameter. This results in an almost homogeneous distribution of rigidity over the periphery. Depending on the degree of overlap, the ball gaps of the one ball row are filled partially by the balls of the second row. In this way, the outer ring is supported in the region of the ball gaps, so that only a small flexion takes place.

In a further favorable form of embodiment, an odd number of rolling elements is used. Through this measure, a rigidity jump caused by a rotation of the adjusting shaft can be reduced. In the case of an even number of rolling elements, the gearing is either very stiffly supported in radial direction through two opposing rolling elements or, after a rotation of the adjusting shaft through one ½ of a ball pitch, in contrast, the gearing is supported softly in radial direction only through the two gaps.

It is advantageous to use a rolling bearing with a smaller rolling element spacing in which a larger number of rolling elements of a smaller rolling element size are used. In this connection, a rolling element number of ≧17 has proved to be advantageous. Particularly advantageous embodiments use ≧21 rolling elements. The use of many small rolling elements enables a particularly good support because the gaps between the individual rolling elements are minimized.

It is further advantageous if the elastic radial flexion of the spur gear and the outer ring between two rolling elements has a maximum value of 0.3×m, wherein m stands for the normal module of the gearing. This assures a good overall support even in the gaps between the individual rolling elements. This approach is intended to apply to the radial rigidity over the periphery and over the width of the bearing. The elastic flexion is defined as

w_{ges}=Fᵣ/c_{ges}

with
Fᵣ.—maximum radial load out of the gearing, assumed as a point load at the center between two rolling elements
c._{ges}—Total bending rigidity of the bending beam between two rolling elements, made up of rigidity of the outer ring and rigidity of the spur gear (damping losses between the two rings neglected)

$${c}_{ges} = \frac{48}{{S}^{3}} \cdot ( {E}_{AR} \cdot I {y}_{AR} + {E}_{SR } \cdot I {y}_{SR} )$$

with
s—chord length between two rolling elements (simplified assumption as straight bending beam)
E_{AR}—E-Module Outer ring
E_{SR}—E-Module spur gear
Iy_{AR}—surface moment of the AR about the bending axis (simplified assumption as rectangular cross-section)
Iy_{SR}—surface moment of the spur gear about the bending axis (simplified assumption as rectangular cross-section)

s=2×r×sin(γ/2)

with
r—radius of the rolling element pitch circle
Y—rolling element angular pitch gamma

In a further advantageous form of embodiment, the shaft transmission is used as a triple shaft adjusting transmission for adjusting and fixing the phase position of a camshaft of an internal combustion engine relative to a crankshaft. The shaft transmission can, however, also be used in reduction devices for adjusting drives.

An alternate embodiment of the shaft transmission also serves for achieving the object of the invention. In the case of the shaft transmission claimed in this claim, the shaft generator comprises, in place of a rolling bearing, a low-lash sliding bearing. A good support of the gearing can likewise be assured through the sliding bearing. This enables the possible danger of a clamping or damage to the transmission components to be minimized.

### BRIEF DESCRIPTION OF THE DRAWINGS

Further advantages, details and developments of the invention result from the following description of preferred forms of embodiment made with reference to the appended drawing. The drawings show:

FIG. 1, a partial region of a shaft generator of the prior art;

FIG. 2, a longitudinal section through a shaft generator of the prior art compared to a shaft generator used in a shaft transmission of the invention;

FIG. 3, a longitudinal section through a shaft generator used in a shaft transmission of the invention, comprising rolling elements arranged offset to one another;

FIG. 4, an illustration of the rigidity curve of the optimized solution of the invention in comparison to the prior art; and

FIG. 5, a longitudinal section through the shaft generator used in the shaft transmission of the invention, comprising axially overlapping rolling elements.

### DETAILED DESCRIPTION OF THE PREFERRED EMBODIMENTS

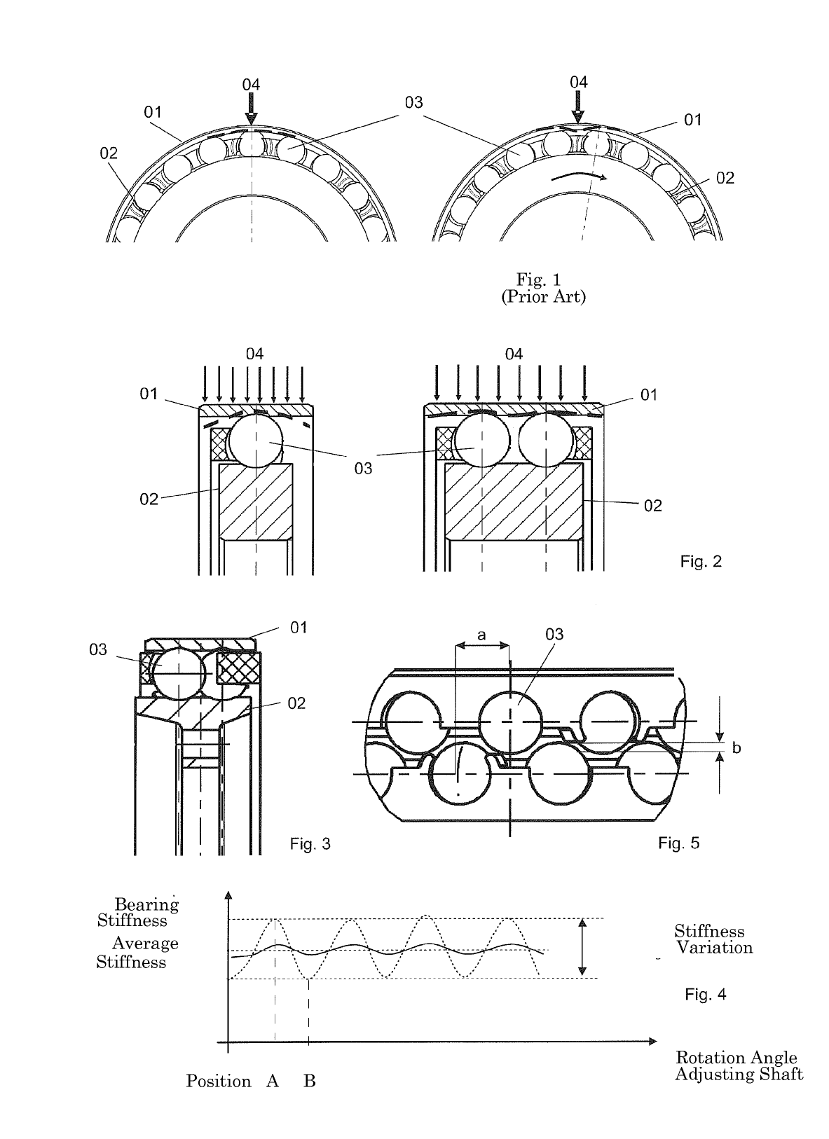

FIG. 1 shows a partial region of a shaft generator of the prior art. Normally used in the shaft generator of the prior art are single row rolling bearings comprising an outer ring 01, an inner ring 02 and a row of rolling elements 03 arranged between the outer ring 01 and the inner ring 02. A radial component force 04 out of the gearing acts on the shaft generator. In the left-hand side illustration, a rolling element 03 is situated directly under the tooth mesh. This guarantees a rigid radial support of a flexible spur gear of a shaft transmission. In the right-hand side illustration, a gap 05 situated between two rolling elements 03 is arranged under the tooth mesh. Through this measure, it is, at present, only possible to realize a soft radial support. It is clearly perceptible from the illustration that the outer ring 01 yields when a gap 05 runs into the load zone (broken line). The flexible spur gear gets deformed in the same manner as the outer ring 01.

FIG. 2 shows a longitudinal section through a shaft generator of the prior art (left-hand illustration) compared to a shaft generator used in a shaft transmission of the invention (right-hand illustration). What is shown is the radial support realized through the tooth width. It can be seen that, in the load zone itself, a change in the radial clamping takes place through the tooth width. As illustrated on the left, in a single row bearing, the outer ring 01 can deviate under the action of the radial component force 04 (broken line), and this results in an unfavorable distribution of the contact pressure in the tooth contact. Under axially unsymmetrical load input, this can lead to a stronger twisting of the periphery of flexible spur gear between the loaded and non-loaded sectors. Due to the poorer support in the gearing, it is more probable for the shaft transmission to be overloaded and clamp or trip. From the right hand illustration, it can be seen that the deformation of the outer ring 01 (broken line) is substantially reduced through the use of a double row bearing. Thus, the flexible spur gear has a better support, so that the danger of overloading of the transmission and of possible clamping and damage of transmission components can be considerably reduced.

FIG. 3 shows a longitudinal section through a shaft generator used in a shaft transmission of the invention comprising rolling elements arranged offset to one another. In this form of embodiment, the tooth mesh is substantially always supported directly through rolling elements 03. Thus, a constant, stiff radial support is always given.

FIG. 4 shows an illustration of the rigidity curve of the solution, optimized according to the invention in comparison to the prior art. The broken curve shows the rigidity pattern of the bearing of the prior art. The continuous curve represents the rigidity pattern of the bearing used in the shaft transmission of the invention. At the points A, in which a rolling element is situated in the load zone, the curves reach a maximum, and at the points B, in which a rolling element gap is situated in the load zone, a minimum. The illustration clearly shows that a bearing of the prior art (broken curve) manifests larger rigidity fluctuations than the optimized solution of the invention.

FIG. 5 shows a longitudinal section through the shaft generator used in the shaft transmission of the invention, comprising axially overlapping rolling elements. The ball tracks of the two rows of rolling elements show an axial overlap b. In addition, the rolling elements 03 are arranged offset to one another in peripheral direction by a ball offset a.

### LIST OF REFERENCE NUMERALS

01 Outer ring
02 Inner ring
03 Rolling elements
04 Radial component force
05 Gap
a Ball offset in peripheral direction
b Axial overlap of ball tracks

1. A shaft transmission comprising at least one annulus comprising an inner gearing, a flexible spur gear arranged within the annulus and comprising an outer gearing, and a shaft generator for deflecting the spur gear in a radial direction arranged within the spur gear, a torque-transmitting connection being created between the annulus and the spur gear at two opposing points of the spur gear, the shaft generator comprising a ring having an elliptical outer periphery and an elliptically shaped rolling bearing applied to said outer periphery, said rolling bearing comprising an outer ring, an inner ring and two rows of rolling elements arranged between the outer ring and the inner ring.

2. A shaft transmission according to claim 1, wherein the rolling elements are needle rollers or cylindrical rollers.

3. A shaft transmission according to claim 1, wherein the rolling elements are arranged offset to one another.

4. A shaft transmission according to claim 1, wherein the rolling elements overlap one another in an axial direction.

5. A shaft transmission according to claim 1, wherein the rolling elements are arranged in a rolling element cage, and through a configuration of the rolling element cage, a contact of the rolling elements with one another is avoided.

6. A shaft transmission according to claim 1, wherein an uneven number of rolling elements is used.

7. A shaft transmission according to claim 1, wherein an elastic radial flexion of the spur gear and the outer ring between two of the rolling elements has a maximum value of 0.3*m, with m being a normal module of the gearing.

8. A shaft transmission according to claim 1, wherein the shaft transmission is configured as a triple shaft transmission for adjusting and fixing a phase position of a camshaft of an internal combustion engine relative to a crankshaft.

9. A shaft transmission according to claim 1, wherein the shaft transmission is configured as a reduction device for an adjusting drive.

10. A shaft generator for deflecting a spur gear of a shaft transmission in a radial direction, said shaft generator comprising a ring comprising an elliptical outer periphery and an elliptically shaped rolling bearing applied to said elliptical, outer periphery, said rolling bearing comprising an outer ring, an inner ring and two rows of rolling elements arranged between the outer ring and the inner ring.
